(19) United States
(12) Patent Application Publication
(10) Pub. No.: US 2025/0340212 A1
(43) Pub. Date: Nov. 6, 2025

(54) IMPORTANCE SAMPLING GUIDED POLICY TRAINING

(71) Applicants: Honda Motor Co., Ltd., Tokyo (JP); The Board of Trustees of the Leland Stanford Junior University, Stanford, CA (US)

(72) Inventors: Mike TIMMERMAN, Stanford, CA (US); Mansur M. ARIEF, Mountain View, CA (US); Jiachen LI, Riverside, CA (US); Mykel J. KOCHENDERFER, Palo Alto, CA (US); David Francis ISELE, Sunnyvale, CA (US)

(21) Appl. No.: 19/063,748

(22) Filed: Feb. 26, 2025

Related U.S. Application Data
(60) Provisional application No. 63/642,228, filed on May 3, 2024.

(51) Int. Cl. B60W 60/00; G06N 3/006

(52) U.S. Cl. CPC B60W 60/001; G06N 3/006; B60W 2540/30

(57) ABSTRACT

According to one aspect, a importance sampling guided policy training may be achieved by training a set of baseline social policies for an agent based on setting a characteristic for the agent to three or more different levels, training a meta-policy based on sampling from a continuous distribution of the three or more different levels based on a minimum level and a maximum level, regularizing the meta-policy based on the trained set of baseline social policies, and training an ego-policy for an ego-agent based on a training distribution and the regularized meta-policy. The training distribution may be importance sampling (IS) optimized.

### CROSS-REFERENCE TO RELATED APPLICATIONS

This application claims the benefit of U.S. Provisional Patent Application, Ser. No. 63/642,228 (Attorney Docket No. H1241109US01) entitled “OPTIMIZED GUIDED META TRAINING FOR INTELLIGENT AGENTS UNDER HIGHLY INTERACTIVE DRIVING SCENARIOS”, filed on May 3, 2024; the entirety of the above-noted application(s) is incorporated by reference herein.

### BACKGROUND

Training intelligent agents to navigate highly interactive driving scenarios, such as intersections, presents significant challenges. Traditional training methods using naturalistic distributions of driving scenarios often fail due to the rarity of boundary interactions, while uniform distribution approaches tend to overemphasize extreme cases, thus impairing the agents' performance under common driving conditions.

### BRIEF DESCRIPTION

According to one aspect, a system for importance sampling guided policy training may include a processor and a memory. The memory may store one or more instructions. The processor may execute one or more of the instructions stored on the memory to perform one or more acts, actions, and/or steps, such as training a set of baseline social policies for an agent based on setting a characteristic for the agent to three or more different levels, training a meta-policy based on sampling from a continuous distribution of the three or more different levels based on a minimum level and a maximum level, regularizing the meta-policy based on the trained set of baseline social policies, and training an ego-policy for an ego-agent based on a training distribution and the regularized meta-policy. The training distribution may be importance sampling (IS) optimized.

The characteristic may be an aggressiveness level associated with operation of the agent in a driving environment. The ego-policy may be trained based on two or more of a generalized distribution of the three or more different levels of the characteristic, a naturalistic distribution derived from real-world driving data, and a proposed training distribution utilizing a distribution including a first set of scenarios and a second set of scenarios less common than the first set of scenarios. An importance weight may adjust for a discrepancy between the naturalistic distribution and the proposed training distribution. The processor may refine the training distribution based on a cross-entropy (CE) algorithm. The processor may train an updated ego-policy based on the refined training distribution. The training distribution may be based on a Gaussian Mixture Model (GMM). The GMM may utilize parameters derived from a set of IS proposal distributions generated during an evaluation phase. The processor may assign equal weights to each component of the GMM. A number of components of the GMM may be the same as a number of ego-policy training iterations.

According to one aspect, a computer-implemented method for importance sampling guided policy training may include training a set of baseline social policies for an agent based on setting a characteristic for the agent to three or more different levels, training a meta-policy based on sampling from a continuous distribution of the three or more different levels based on a minimum level and a maximum level, regularizing the meta-policy based on the trained set of baseline social policies, and training an ego-policy for an ego-agent based on a training distribution and the regularized meta-policy. The training distribution may be importance sampling (IS) optimized.

According to one aspect, a system for importance sampling guided policy training may include a processor and a memory. The memory may store one or more instructions. The processor may execute one or more of the instructions stored on the memory to perform one or more acts, actions, and/or steps, such as training a set of baseline social policies for an agent based on setting a characteristic for the agent to three or more different levels, training a meta-policy based on sampling from a continuous distribution of the three or more different levels based on a minimum level and a maximum level, regularizing the meta-policy based on the trained set of baseline social policies, and training an ego-policy for an ego-agent based on a Gaussian Mixture Model (GMM) training distribution and the regularized meta-policy. The training distribution may be importance sampling (IS) optimized.

### BRIEF DESCRIPTION OF THE DRAWINGS

FIG. 1 is an exemplary flow diagram of a computer-implemented method for importance sampling guided policy training, according to one aspect.

FIG. 2 is an exemplary component diagram of a system for importance sampling guided policy training, according to one aspect.

FIG. 3 is an exemplary process flow in association with importance sampling guided policy training, according to one aspect.

FIG. 4 is an exemplary algorithm in association with importance sampling guided policy training, according to one aspect.

FIG. 5 is an illustration of an example computing environment where one or more of the provisions set forth herein are implemented, according to one aspect.

FIG. 6 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

An “agent”, as used herein, may be a machine that moves through or manipulates an environment. Exemplary agents may include robots, vehicles, or other self-propelled machines. The agent may be autonomously, semi-autonomously, or manually operated.

Autonomous driving agents may be tasked with navigating complex, interactive environments, such as congested and unsignaled intersections. The direct training of these agents using a naturalistic distribution of driving scenarios may be notably inefficient due to the imbalanced frequency of scenarios; common scenarios may be overrepresented while interactive boundary scenarios may be rare yet useful for training. However, overemphasis of extreme scenarios sampled disproportionately during training may cause performance degradation for more common or non-boundary driving scenarios or conditions.

The system for importance sampling guided policy training introduces a training framework that integrates guided meta reinforcement learning (RL) with importance sampling (IS) to optimize training distributions for navigating highly interactive driving scenarios, such as intersections, for example. Unlike other methods that may underrepresent boundary interactions or overemphasize extreme cases during training, the system for importance sampling guided policy training strategically may adjust a training distribution towards more challenging driving behaviors using the IS proposal distribution and apply an importance ratio to debias the result. By estimating a naturalistic distribution from real-world datasets and employing mixture model for iterative training refinements, the framework of the system for importance sampling guided policy training ensures a balanced focus across common and extreme driving scenarios.

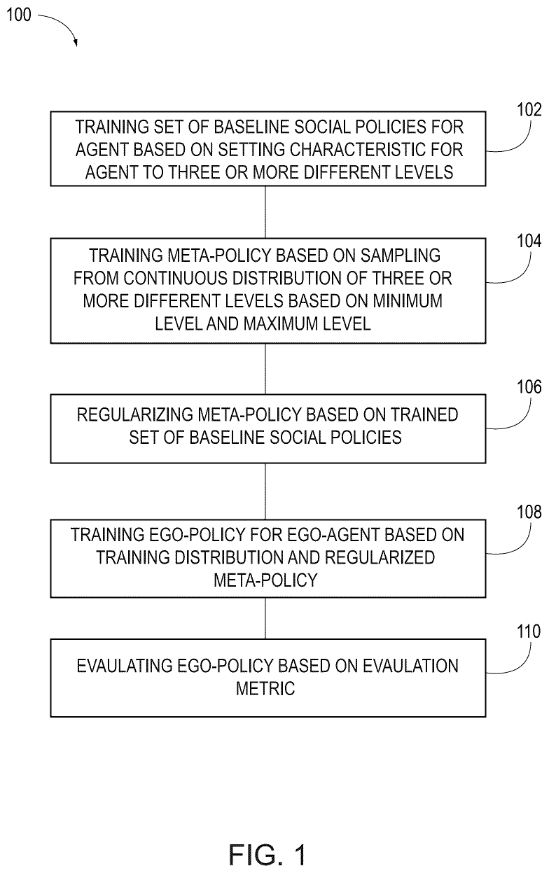

FIG. 1 is an exemplary flow diagram of a computer-implemented method 100 for importance sampling guided policy training, according to one aspect. For example, the computer-implemented method 100 for importance sampling guided policy training may include training 102 a set of baseline social policies for an agent based on setting a characteristic for the agent to three or more different levels, training 104 a meta-policy based on sampling from a continuous distribution of the three or more different levels based on a minimum level and a maximum level, regularizing 106 the meta-policy based on the trained set of baseline social policies, training 108 an ego-policy for an ego-agent based on a training distribution and the regularized meta-policy, and evaluating 110 the ego-policy based on an evaluation metric. Further, the training distribution may be importance sampling (IS) optimized.

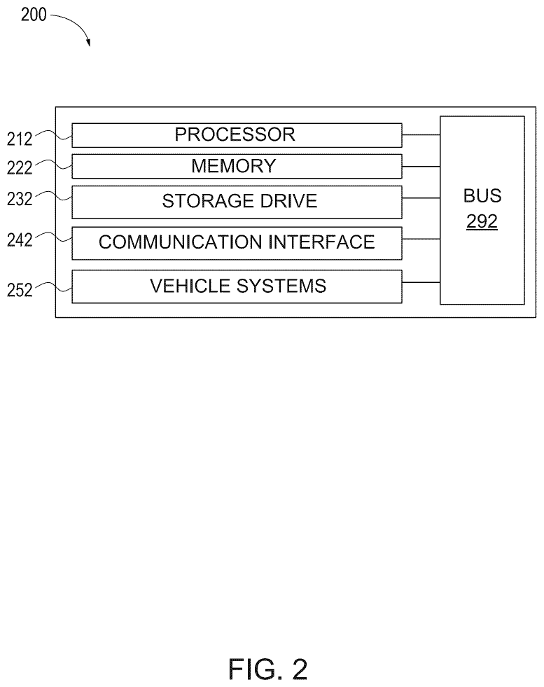

FIG. 2 is an exemplary component diagram of a system 200 for importance sampling guided policy training, according to one aspect. The system 200 for importance sampling guided policy training may include a processor 212, a memory 222, a storage drive 232, a communication interface 242, and a bus 292. The respective components (e.g., the processor 212, the memory 222, the storage drive 232, the communication interface 242, and the bus 292) may be operably connected and in computer communication with one another. Further, the communication interface 242 may enable computer communication with external devices (e.g., a mobile device, a remote server, etc.). According to one aspect, an ego-policy generated by the system 200 for importance sampling guided policy training may be implemented (e.g., stored on the storage drive 232 and executed by the processor 212 and memory 222) on an autonomous vehicle (e.g., which may be the system 200) and the autonomous vehicle may utilize one or more vehicle systems 252 (e.g., including controllers, actuators, etc.) to operate according to the ego-policy.

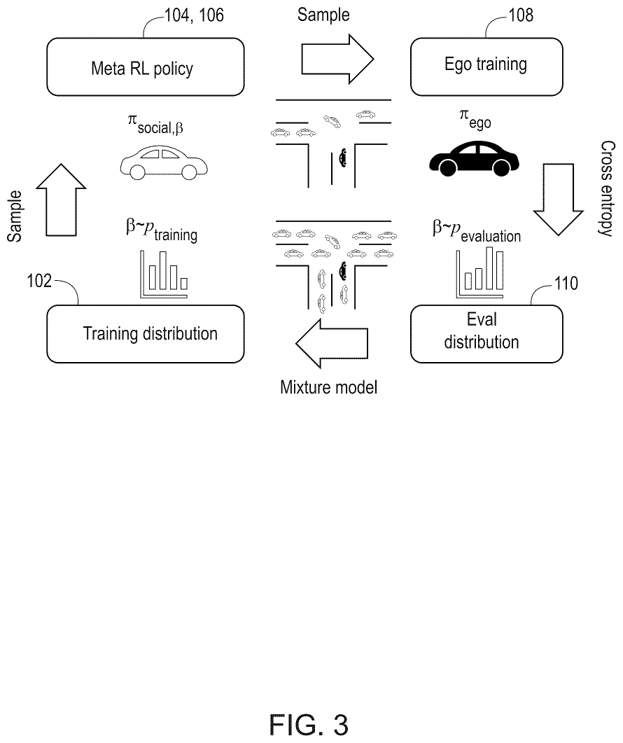

In any event, the memory 222 may store one or more instructions and the processor 212 may execute one or more of the instructions stored on the memory 222 to perform one or more acts, actions, and/or steps. FIG. 3 is an exemplary process flow in association with importance sampling guided policy training, according to one aspect. FIGS. 2-3 are now described in conjunction and with reference to one another.

The system 200 for importance sampling guided policy training may implement a framework employing IS both during training and evaluation to mitigate the challenge of overemphasis on extreme scenarios. The training framework may integrate a guided meta-RL agent training approach with IS, optimizing the training distribution to efficiently sample interactive boundary scenarios without disproportionately emphasizing these scenarios. The IS optimized training approach may strategically bias sampling towards more intense driving situations using an IS proposal derived through the cross-entropy method and compute an importance ratio based on the underlying naturalistic distribution to provide an unbiased reward estimate during training.

The system 200 for importance sampling guided policy training may include a framework that integrates IS in both policy evaluation and training for autonomous driving. The framework aims to utilize an optimized IS to enhance both the evaluation and subsequent training efficiency of autonomous driving agents. This dual application of IS may facilitate generating boundary scenarios that are not only useful for robust policy assessment but also beneficial for iterative policy enhancement.

### Modeling and Objective

The processor 212 may formulate a driving scenario as a partially observable stochastic game, where the interaction dynamics may be described using an interactive driving model. At any given time t, the scenario may be defined by a state sₜ. The objective for the ego-policy π_{ego}* may be to maximize its expected cumulative reward over time, formulated as:

$${π}_{ego}^{*} = arg \begin{matrix}max \\ π ∈ {\prod }_{ego}\end{matrix} [ {\sum }_{t = 0}^{∞} {γ}^{t} R ( {s}_{t} , π ( {s}_{t} ) ) ] \qquad ( 1 )$$

where R represents the reward function for the ego vehicle, γ represents the discount factor, indicating a decreasing importance of future rewards, and an expectation may be taken over state transitions. The ego-policy π may map a state space δ to an action space [symbol] _{ego}, with Π_{ego} representing the feasible policy set for the ego agent.

### Social Policy and Meta-Policy Training

According to one aspect, the processor 212 may train a set of baseline social policies for an agent based on setting a characteristic for the agent to three or more different levels. According to one aspect, the characteristic may be an aggressiveness level associated with operation of the agent in a driving environment. The processor 212 may train a meta-policy based on sampling from a continuous distribution of the three or more different levels based on a minimum level and a maximum level.

The social agents may be modeled with a policy π_{social}, parameterized by β, indicative of a characteristic (e.g., a level of aggressiveness) of the social agents (e.g., agents other than the ego-agent). The policy for each social agent may be optimized to maximize:

$$\begin{matrix}max \\ π ∈ {\prod }_{social}\end{matrix} [ {\sum }_{t = 0}^{∞} {γ}^{t} ( {r}^{goal} ( {s}_{t} , {a}_{social , t} ) + β {r}^{speed} ( {s}_{t} , {a}_{social , t} ) ) ] \qquad ( 2 )$$

where a_{social, t}=π_{social,β(s}_{ₜ}₎, and r^{goal} and r^{speed} may represent the reward components for achieving the goal and maintaining speed or velocity, respectively.

To train a diverse set of social behaviors, the processor 212 may employ a meta-policy π_{social},β using a two-stage approach. In a first stage, baseline policies π_{social},β may be trained for discrete preferences within a set B̅={β̅¹, . . . , β̅^{m}}. Each baseline policy π_{social,β̅}_{ⁱ} may target a specific behavioral model. In a second stage, the meta-policy π_{social,β} may be trained by sampling f from a continuous distribution U(βₘᵢₙ,βₘₐₓ), and may be regularized to approximate a nearest baseline policy using the regularization loss:

$${ℒ}_{reg} ( {π}_{social , β} ) = {\sum }_{\overline{β} ∈ \overline{B}} ( \vert \overline{β} - β \vert \leq d ) {D}_{KL} ( {π}_{social , \overline{β}}^{*} ‖ {π}_{social , β} ) \qquad ( 3 )$$

where [symbol] may be an indicator function and D_{KL} may be the Kullback-Leibler divergence. This approach facilitates the synthesis of a diverse meta-policy capable of adapting to various social behaviors. According to one aspect, β may be utilizing during training only.

### Ego-Policy Training

The processor 212 may train an ego-policy for an ego-agent based on a training distribution and the regularized meta policy. The ego-policy may be trained based on two or more of a generalized distribution of the three or more different levels of the characteristic, a naturalistic distribution derived from real-world driving data, and a proposed training distribution utilizing a distribution including a first set of scenarios and a second set of scenarios less common than the first set of scenarios.

The ego-policy π_{ego} may be trained against the backdrop of diverse social policies. The processor 212 may consider several strategies for the training distribution of β, denoted by p_{training}, to prepare the ego-policy for a spectrum of social behaviors, as described herein.

A generalized ego-policy (GEP) may utilize a uniform or continuous distribution U(βₘᵢₙ, βₘₐₓ) for p_{training} to prepare the ego-policy for a wide range of social behaviors, while potentially overfitting to less common aggressive behaviors.

A naturalistic ego-policy (NEP) may utilize a distribution p_{naturalistic} derived from real-world driving data to focus on common social behaviors, while potentially neglecting rarer or uncommon boundary scenarios.

An optimized ego-policy (OEP) may utilize an optimized proposal distribution p_{optimized} for p_{training}, thereby providing a balanced approach that covers both common and rare or uncommon scenarios. The training objective for the ego-policy under this approach may be formulated as:

$$\begin{matrix}max \\ π ∈ {\prod }_{ego}\end{matrix} [ {\sum }_{t = 0}^{∞} {γ}^{t} R ( {s}_{t} , π ( {s}_{t} ) ) \cdot \frac{{p}_{naturalistic} ( β )}{{p}_{optimized} ( β )} ] \qquad ( 4 )$$

where an importance weight in association with the IS may adjust for a discrepancy between the naturalistic distribution and the proposed training distribution.

### Ego Policy Evaluation

The training distribution may be importance sampling (IS) optimized. For example, IS, which is commonly utilized for evaluation, may be integrated into an optimized training distribution using both cross-entropy (CE) and mixture models (MM).

The evaluation of π_{ego} may be designed to mirror realistic conditions, such as by focusing on the policy's effectiveness in managing collisions or delays at intersections. The processor 212 may utilize the cross-entropy (CE) method to refine the IS proposal distribution pₑᵥₐᵤₗₐₜᵢₒₙ, which may be aimed at generating highly informative and challenging scenarios for robust evaluation.

### CE Iteration

The processor 212 may initiate the CE algorithm with a Gaussian distribution N(μ₀, σ), where σ may be set to a fixed value. The mean may be then iteratively adjusted based on the performance data from a lower threshold percentile reward of simulated scenarios, ensuring focus on scenarios that reveal potential weaknesses in the ego-policy. In each iteration, values of β may be sampled from this Gaussian distribution to simulate driving scenarios that evaluate π_{ego}. This iterative optimization process may be repeated until the parameters of the distribution stabilize, such as when indicated by a μ change less than a threshold amount (e.g., 0.01) between iterations. In this way, the processor 212 may refine the training distribution based on a cross-entropy (CE) algorithm and train an updated ego-policy based on the refined training distribution.

### Final Metric

To quantify the effectiveness of the ego-policy under realistic conditions, the processor 212 may compute a final evaluation metric as:

$${ϕ}_{{π}_{ego}} = \frac{1}{{N}_{s}} {\sum }_{i = 1}^{{N}_{s}} \{ failure \vert {π}_{ego} \} \frac{{p}_{naturalistic} ( {β}_{i} )}{{p}_{optimized} ( {β}_{i} )} \qquad ( 5 )$$

where N_{S} is a number of samples generated from pₑᵥₐᵤₗₐₜᵢₒₙ.

This final evaluation metric may provide an unbiased estimate of a naturalistic failure rate:

$${π}_{ego} = {β}_{} [ \{ failure \vert {π}_{ego} \} ] = [ {\hat{ϕ}}_{{π}_{ego}} ] \qquad ( 6 )$$

The IS approach ensures that although the scenarios may be generated from a biased distribution pₑᵥₐᵤₗₐₜᵢₒₙ, the final performance estimate remains unbiased, highlighting its strength in considering rarer or uncommon boundary situations without overemphasizing them, thereby providing the advantage of a reliable measure of its real-world efficacy.

### Augmenting Training Distribution

According to one aspect, the training distribution may be based on a Gaussian Mixture Model (GMM). In order to refine the training of the ego-policy π_{ego}, the processor 212 may integrate the GMM into the training distribution. The GMM may utilize parameters derived from a set of IS proposal distributions generated during the evaluation phase. A mean vector of the GMM may include all the means from the distributions {pₑᵥₐᵤₗₐₜᵢₒₙ}, and the standard deviation vector may include the corresponding σ values. The processor 212 may assign equal weights to each component of the GMM. The processor 212 may assign equal weights to each component of the mixture, represented by

$$\frac{1}{k} ,$$

where k may be the number of ego-policy training iterations. Thus, a number of components of the GMM may be the same as a number of ego-policy training iterations.

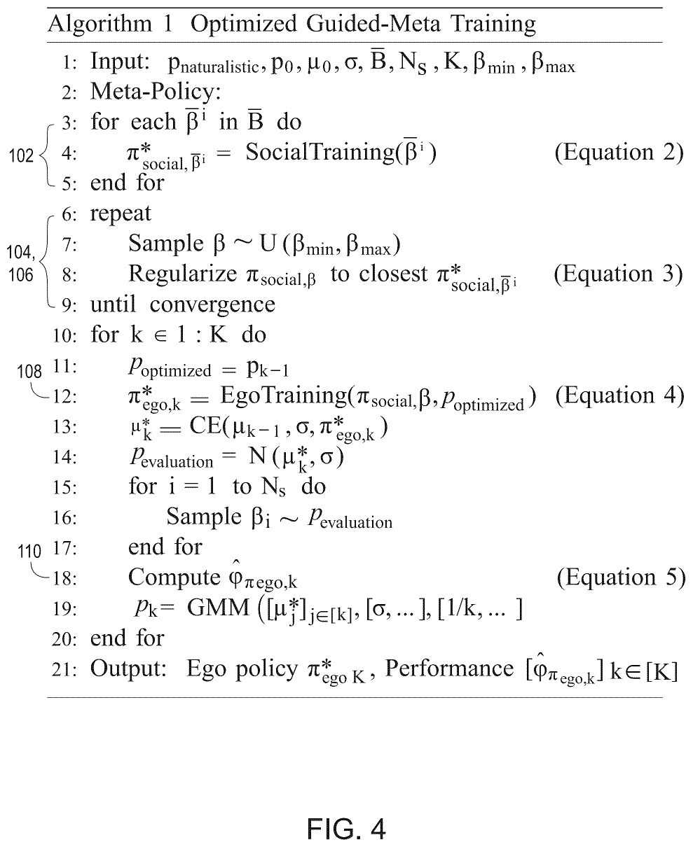

In this way, system 200 for importance sampling guided policy training may efficiently utilize the diverse and specific scenarios identified during the evaluation phase to enhance the training environment. In addition, the use of the IS based reward strategy from Equation (4) may guarantee that the training process yields an unbiased estimation of the ego-policy's performance under real-world driving conditions. This integration ensures that the modifications made during the training phase lead to genuine improvements in the policy's performance. The GMM policy may be used as a current p_{optimized} distribution. The full framework may be summarized in the Algorithm of FIG. 4.

The processor 212 may regularize the meta-policy based on the trained set of baseline social policies. The processor 212 may regularize the meta-policy based on the trained set of baseline social policies.

In this way, the computer-implemented method 100 for importance sampling guided policy training of FIG. 1 and the system 200 for importance sampling guided policy training of FIG. 2 may provide the benefit and advantage of providing a more robust model due to the training based on one or more boundary scenarios or interactions while not overemphasizing extreme cases, thereby enhancing the ego-policy performance under non-boundary scenarios or more common driving conditions. Thus, the IS optimized guided meta-RL policy training framework provided by the present disclosure may effectively balance the training for both common and uncommon or boundary driving scenarios, thereby enhancing the adaptability and efficacy of the training process by reflecting real-world driving dynamics accurately and improving the generalizability of the trained ego-policies across diverse driving situations or scenarios. These contributions collectively enhance the adaptability and efficacy of autonomous driving agents in the technical field of autonomous driving, paving the way for efficient and more reliable autonomous vehicle operations in highly interactive real-world conditions.

FIG. 4 is an exemplary algorithm in association with importance sampling guided policy training, according to one aspect. Lines 3-5 of the algorithm of FIG. 4 relate to training a set of baseline social policies based on varying levels of a characteristic, such as aggressiveness for a social agent. Lines 6-9 of the algorithm of FIG. 4 relate to training a meta-policy based on sampling from a continuous distribution of the three or more different levels based on a minimum level and a maximum level and regularizing the meta-policy based on the trained set of baseline social policies. Lines 11-14 of the algorithm of FIG. 4 relate to training an ego-policy for an ego-agent based on a training distribution and the regularized meta-policy. Lines 15-17 of the algorithm of FIG. 4 relate to sampling the IS proposal distribution. Line 18 of the algorithm of FIG. 4 relates to computing a final evaluation metric. Line 19 of the algorithm of FIG. 4 relates to computing a subsequent iteration of the training distribution.

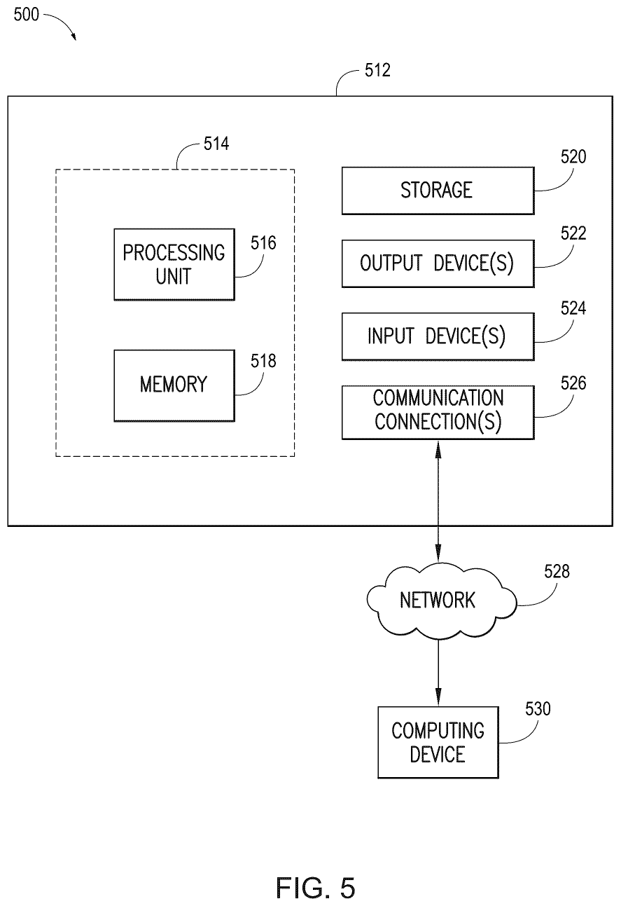

FIG. 5 and the following discussion provide a description of a suitable computing environment to implement aspects of one or more of the provisions set forth herein. The operating environment of FIG. 5 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 5 illustrates a system 500 including a computing device 512 configured to implement one aspect provided herein. In one configuration, the computing device 512 includes at least one processing unit 516 and memory 518. Depending on the exact configuration and type of computing device, memory 518 may be volatile, such as RAM, non-volatile, such as ROM, flash memory, etc., or a combination of the two. This configuration is illustrated in FIG. 5 by dashed line 514.

In other aspects, the computing device 512 includes additional features or functionality. For example, the computing device 512 may include additional storage such as removable storage or non-removable storage, including, but not limited to, magnetic storage, optical storage, etc. Such additional storage is illustrated in FIG. 5 by storage 520. In one aspect, computer readable instructions to implement one aspect provided herein are in storage 520. Storage 520 may store other computer readable instructions to implement an operating system, an application program, etc. Computer readable instructions may be loaded in memory 518 for execution by the at least one processing unit 516, for example.

The term “computer readable media” as used herein includes computer storage media. Computer storage media includes volatile and nonvolatile, removable, and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 512. Any such computer storage media is part of the computing device 512.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 512 includes input device(s) 524 such as keyboard, mouse, pen, voice input device, touch input device, infrared cameras, video input devices, or any other input device. Output device(s) 522 such as one or more displays, speakers, printers, or any other output device may be included with the computing device 512. Input device(s) 524 and output device(s) 522 may be connected to the computing device 512 via a wired connection, wireless connection, or any combination thereof. In one aspect, an input device or an output device from another computing device may be used as input device(s) 524 or output device(s) 522 for the computing device 512. The computing device 512 may include communication connection(s) 526 to facilitate communications with one or more other devices 530, such as through network 528, for example.

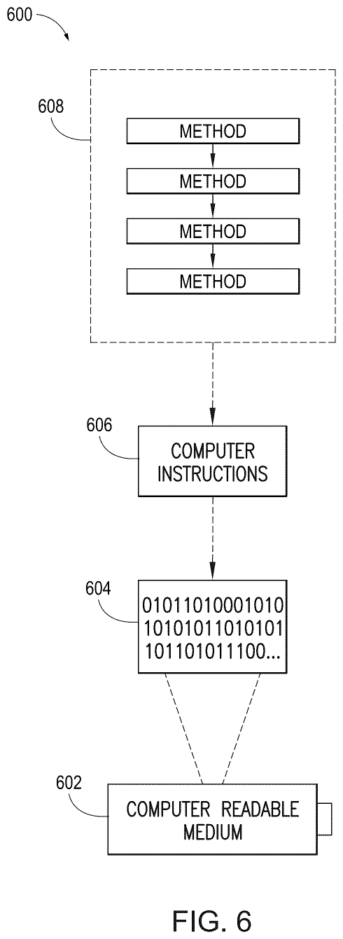

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 602, such as a CD-R, DVD-R, flash drive, a platter of a hard disk drive, etc., on which is encoded computer-readable data 604. This encoded computer-readable data 604, such as binary data including a plurality of zero's and one's as shown in 604, in turn includes a set of processor-executable computer instructions 606 configured to operate according to one or more of the principles set forth herein. In this implementation 600, the processor-executable computer instructions 606 may be configured to perform a method 608, such as the computer-implemented method 100 of FIG. 1. In another aspect, the processor-executable computer instructions 606 may be configured to implement a system, such as the system 200 for importance sampling guided policy training of FIG. 2. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for importance sampling guided policy training, comprising:
a memory storing one or more instructions;
a processor executing one or more of the instructions stored on the memory to perform:
training a set of baseline social policies for an agent based on setting a characteristic for the agent to three or more different levels;
training a meta-policy based on sampling from a continuous distribution of the three or more different levels based on a minimum level and a maximum level;
regularizing the meta-policy based on the trained set of baseline social policies; and
training an ego-policy for an ego-agent based on a training distribution and the regularized meta-policy, wherein the training distribution is importance sampling (IS) optimized.

2. The system for importance sampling guided policy training of claim 1, wherein the characteristic is an aggressiveness level associated with operation of the agent in a driving environment.

3. The system for importance sampling guided policy training of claim 1, wherein the ego-policy is trained based on two or more of:
a generalized distribution of the three or more different levels of the characteristic;
a naturalistic distribution derived from real-world driving data; and
a proposed training distribution utilizing a distribution including a first set of scenarios and a second set of scenarios less common than the first set of scenarios.

4. The system for importance sampling guided policy training of claim 3, wherein an importance weight adjusts for a discrepancy between the naturalistic distribution and the proposed training distribution.

5. The system for importance sampling guided policy training of claim 1, wherein the processor refines the training distribution based on a cross-entropy (CE) algorithm.

6. The system for importance sampling guided policy training of claim 5, wherein the processor trains an updated ego-policy based on the refined training distribution.

7. The system for importance sampling guided policy training of claim 1, wherein the training distribution is based on a Gaussian Mixture Model (GMM).

8. The system for importance sampling guided policy training of claim 7, wherein the GMM utilizes parameters derived from a set of IS proposal distributions generated during an evaluation phase.

9. The system for importance sampling guided policy training of claim 8, wherein the processor assigns equal weights to each component of the GMM.

10. The system for importance sampling guided policy training of claim 9, wherein a number of components of the GMM is the same as a number of ego-policy training iterations.

11. A computer-implemented method for importance sampling guided policy training, comprising:
training a set of baseline social policies for an agent based on setting a characteristic for the agent to three or more different levels;
training a meta-policy based on sampling from a continuous distribution of the three or more different levels based on a minimum level and a maximum level;
regularizing the meta-policy based on the trained set of baseline social policies; and
training an ego-policy for an ego-agent based on a training distribution and the regularized meta-policy, wherein the training distribution is importance sampling (IS) optimized.

12. The computer-implemented method for importance sampling guided policy training of claim 11, wherein the characteristic is an aggressiveness level associated with operation of the agent in a driving environment.

13. The computer-implemented method for importance sampling guided policy training of claim 11, wherein the ego-policy is trained based on two or more of:
a generalized distribution of the three or more different levels of the characteristic;
a naturalistic distribution derived from real-world driving data; and
a proposed training distribution utilizing a distribution including a first set of scenarios and a second set of scenarios less common than the first set of scenarios.

14. The computer-implemented method for importance sampling guided policy training of claim 13, wherein an importance weight adjusts for a discrepancy between the naturalistic distribution and the proposed training distribution.

15. The computer-implemented method for importance sampling guided policy training of claim 11, comprising refining the training distribution based on a cross-entropy (CE) algorithm.

16. A system for importance sampling guided policy training, comprising:
a memory storing one or more instructions;
a processor executing one or more of the instructions stored on the memory to perform:
training a set of baseline social policies for an agent based on setting a characteristic for the agent to three or more different levels;
training a meta-policy based on sampling from a continuous distribution of the three or more different levels based on a minimum level and a maximum level;
regularizing the meta-policy based on the trained set of baseline social policies; and
training an ego-policy for an ego-agent based on a Gaussian Mixture Model (GMM) training distribution and the regularized meta-policy, wherein the training distribution is importance sampling (IS) optimized.

17. The system for importance sampling guided policy training of claim 16, wherein the characteristic is an aggressiveness level associated with operation of the agent in a driving environment.

18. The system for importance sampling guided policy training of claim 16, wherein the ego-policy is trained based on two or more of:
a generalized distribution of the three or more different levels of the characteristic;
a naturalistic distribution derived from real-world driving data; and
a proposed training distribution utilizing a distribution including a first set of scenarios and a second set of scenarios less common than the first set of scenarios.

19. The system for importance sampling guided policy training of claim 18, wherein an importance weight adjusts for a discrepancy between the naturalistic distribution and the proposed training distribution.

20. The system for importance sampling guided policy training of claim 16, wherein the processor refines the training distribution based on a cross-entropy (CE) algorithm.
